(19) United States
(12) Patent Application Publication
(10) Pub. No.: US 2025/0314425 A1
(43) Pub. Date: Oct. 9, 2025

(54) AN ARRANGEMENT FOR STATIC CHARGE REDUCTION

(71) Applicants: Indu C. N., Bengaluru, Karnataka (IN); K. Nanda KISHORE, Bengaluru, Karnataka (IN)

(72) Inventors: Indu C. N., Bengaluru, Karnataka (IN); K. Nanda KISHORE, Bengaluru, Karnataka (IN)

(21) Appl. No.: 18/864,533

(22) PCT Filed: Jul. 10, 2023
(86) PCT No.: PCT/IB2023/057052

§ 371 Date: Nov. 10, 2024

(30) Foreign Application Priority Data
May 11, 2022 (IN) 202241027206

(51) Int. Cl. F26B 25/00; F26B 3/084; H05F 3/00

(52) U.S. Cl. CPC F26B 25/009; F26B 3/084; H05F 3/00

(57) ABSTRACT

The invention provides an arrangement for reducing static charge in a fluid bed dryer. The arrangement includes a hollow cylinder having an inner surface and an outer surface. The inner surface has a plurality of slotted projections formed radially at equal intervals along the axis of the hollow cylinder. The outer surface has an ionizing apparatus mounted on each of the slotted projections through a retention means. The arrangement further includes a pair of coupling means at both ends of the hollow cylinder for coupling the arrangement to the hot air supply duct of the fluid bed dryer. On applying a voltage, the ionizing apparatus, generate positive and negative ions into the hollow cylinder. The generated positive and negative ions are carried by the hot air to the sample drying unit of the fluid bed dryer for neutralizing the static charge generated during the drying of the sample.

### FIELD OF INVENTION

The invention generally relates to the field of static charge elimination and more specifically to an arrangement for reducing static charge in a fluid bed dryer.

### BACKGROUND

Fluid bed drying is extensively used for drying of moist powders and granular solids in pharmaceutical and other chemical industries. In fluid bed drying, heat is supplied by the fluidisation gas, or by heating plates or tubes which are immersed in the fluidised layer. Hot drying air is distributed through specially designed perforated plates on which the powder particles are resting. As the velocity of the gas or air increases, the upward forces on the particles increase, causing them to equal the gravitational forces below. Each particle is in direct contact with and is surrounded by the hot gas or air, creating an efficient and uniform drying process.

Generation of static charge is a significant problem in fluid bed dryer. Static charge generate due to rubbing of the powder or granules with each other and with the walls of the dryer. Static charge generation is undesirable in the fluid bed dryer for the reasons including but not limited clinging together of the powder particles leading to lump formation, materials with volatile solvents can get flamed by a spark, hazardous for the people operating the fluid bed dryer. There are various methods available in the art for reducing the static charges generated. One such method is grounding or earthing of the equipment wherein, the static charge is reduced by moving it to the earth. One of the significant disadvantage is effectiveness of the method is limited to conductive materials only and grounding of high resistivity materials do not result in charge dissipation.

Another method for reducing the static charges includes use of interlocking system for controlling the rise in pressure. Disadvantages of interlocking systems include high cost, not useful for areas where the charging of powder is done manually; they do not prevent the development of static charge, but only prevent the explosion from going out of control.

Still another method for reducing static charge in the fluid bed dryer is increasing relative humidity by introduction of humid air. One significant disadvantage is that increasing relative humidity could contaminate products that are hydro sensitive.

Yet another such method disclosed in U.S. Pat. No. 7,905,433 B2 includes addition of isopropyl alcohol to the fluidizing gas for effective dissipation of electrostatic charge within a fluidization chamber. One significant disadvantage of the method is since isopropyl alcohol is highly flammable, there is risk of fire and explosion in the fluid bed dryer.

In yet another method disclosed by Ravel J et'al, static charge removal is achieved by ejection of ions through an ionizing gun into the fluidized bulk material. One significant disadvantage of the method is that the ions ejected from the eliminator cannot penetrate into the bulk of particles, only the particles on the upper surface of the bed are discharged. Hence, the method is not efficient for removal of static charges.

Hence, there is a need for a method for reducing static charge in fluid bed dryer that is cost effective, economical, efficient, safe and can be used in processes which use flammable materials.

### BRIEF DESCRIPTION OF DRAWINGS

So that the manner in which the recited features of the invention can be understood in detail, some of the embodiments are illustrated in the appended drawings. It is to be noted, however, that the appended drawings illustrate only typical embodiments of this invention and are therefore not to be considered limiting of its scope, for the invention may admit to other equally effective embodiments.

FIG. 1 shows a cross section of an arrangement for reducing static charge in a fluid bed dryer, according to an embodiment of the invention.

FIG. 2 shows a schematic representation of an arrangement for reducing static charge in a fluid bed dryer, according to an embodiment of the invention.

FIG. 3 shows an exploded view of an arrangement for reducing static charge in a fluid bed dryer, according to an embodiment of the invention.

### SUMMARY OF THE INVENTION

One aspect of the invention provides an arrangement for reducing static charge in a fluid bed dryer. The arrangement includes a hollow cylinder having an inner surface and an outer surface. The inner surface has a plurality of slotted projections formed radially at equal intervals along the axis of the hollow cylinder. The outer surface has an ionizing apparatus mounted on each of the slotted projections through a retention means. The arrangement further includes a pair of coupling means at both ends of the hollow cylinder for coupling the arrangement to the hot air supply duct of the fluid bed dryer. On applying a voltage, the ionizing apparatus, generate positive and negative ions into the hollow cylinder. The generated positive and negative ions are carried by the hot air to the sample drying unit of the fluid bed dryer for neutralizing the static charge generated during the drying of the sample.

### DETAILED DESCRIPTION OF THE INVENTION

Various embodiments of the invention provide an arrangement for reducing static charge in a fluid bed dryer. Fluid bed drying is a process by which materials including but not limited to powders, granules, tablets, fertilizers, and plastics, are fluidized and dried. In a fluidization process, hot air is introduced at high pressure through a perforated bed of moist solid material. The wet material is lifted from the bottom and suspended in a stream of air (fluidized state). As the hot air passes between the particles of the material, it takes the excess moisture from the particles thus drying the material. Heat transfer is accomplished by direct contact between the wet material and hot gases. Static charge is generated in a fluid bed dryer due to rubbing of the material particles with each other and with the walls of the dryer. The generated static charge can build up to dangerous levels and then discharge unpredictably. If the energy released in the discharge is greater than the minimum ignition energy of the material undergoing drying, then the material will catch fire and explode. The invention provides an arrangement for removing static charges in a fluid bed dryer. The arrangement includes a hollow cylinder having an inner surface and an outer surface. The inner surface has a plurality of slotted projections formed radially at equal intervals along the axis of the hollow cylinder. The outer surface has an ionizing apparatus mounted on each of the slotted projections through a retention means. The arrangement further includes a pair of coupling means at both ends of the hollow cylinder for coupling the arrangement to the hot air supply duct of the fluid bed dryer. On applying a voltage, the ionizing apparatus, generate positive and negative ions into the hollow cylinder. The generated positive and negative ions are carried by the hot air to the sample drying unit of the fluid bed dryer for neutralizing the static charge generated during the drying of the sample. The arrangement as described herein above briefly shall be explained in detail below. All the terms mentioned in the description herein shall be interpreted in their usual and standard meaning unless otherwise specified.

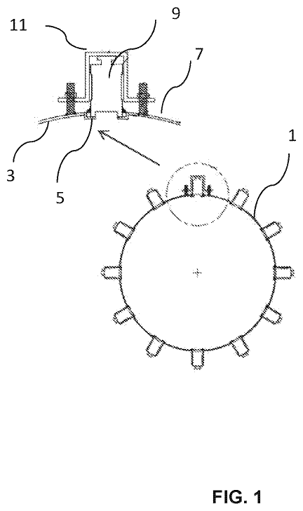

FIG. 1 shows a schematic representation of an arrangement for reducing static charge in a fluid bed dryer, according to an embodiment of the invention. The arrangement includes a hollow cylinder 1 having an inner surface 3 and an outer surface 7. The inner surface 3 has a plurality of slotted projections 5 formed radially at equal intervals along the axis of the hollow cylinder 1. The slotted projections 5 are formed at an interval ranging from 6.5 cm to 7.5 cm. The slotted projection 5, in one example, is formed by slitting the hollow cylinder 1 radially along its horizontal axis and securing a ‘C’ channel bar/U channel bar on the inner surface 3 such that the entire slit is covered by the C channel bar. The outer surface 7 has an ionizing apparatus 9 mounted on each of the slotted projections 5 through a retention means 11. The ionizing apparatus 9 is mounted on the slotted projection 5. In one example of the invention, the ionizing apparatus 9 comprises of a bar air ionizer. The ionizing apparatus 9 is secured on the slotted projection through the retention means 11.

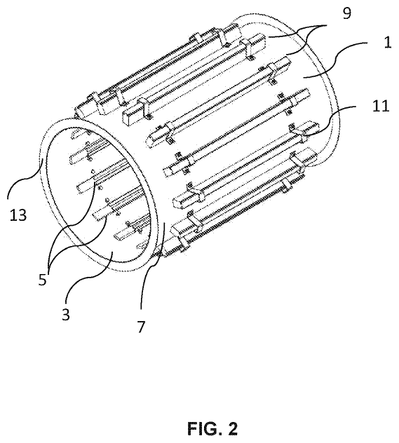

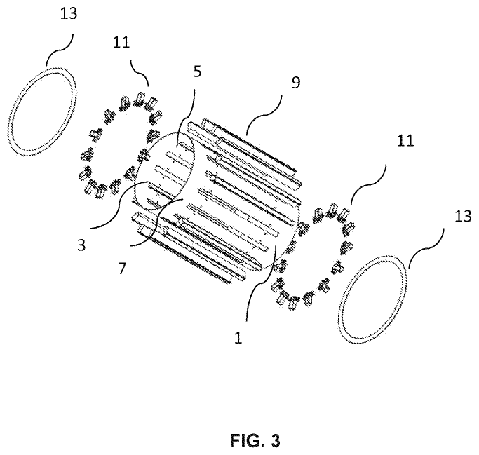

FIG. 2 shows a schematic representation of an arrangement for reducing static charge in a fluid bed dryer, according to an embodiment of the invention and FIG. 3 shows an exploded view of an arrangement for reducing static charge in a fluid bed dryer, according to an embodiment of the invention. The arrangement includes a hollow cylinder 1 having an inner surface 3 and an outer surface 7. The hollow cylinder is made of stainless steel, aluminum, aluminum alloy and other such materials known in the art for high strength. The thickness of the hollow cylinder varies from 2 mm to 5 mm. In one example of the invention, the hollow cylinder 1 is made of stainless steel of thickness 3 mm. The inner surface 3 has a plurality of slotted projections 5 formed radially at equal intervals along the axis of the hollow cylinder 1. The slotted projections 5 are formed at an interval ranging from 6.5 cm to 7.5 cm. The slotted projection 5, in one example, is formed by cutting a slotted hole on the hollow cylinder 1 radially along its horizontal axis and securing a ‘C’ channel bar/U channel bar on the inner surface 3 such that the entire slot is covered by the ‘C’ channel bar/U channel bar. The outer surface 7 has an ionizing apparatus 9 mounted on each of the slotted projections 5 through a retention means 11. The ionizing apparatus 9 is mounted on the slotted projection 5. In one example of the invention, the ionizing apparatus 9 comprises of an air ionizer particularly a bar air ionizer. The ionizing apparatus 9 is secured on the slotted projection through the retention means 11. The retention means 11 includes but is not limited to a clamp, a belt or a locking flat system. In one example of the invention, the ionizing apparatus 9 is secured to the slotted projection 5 through a U clamp 11. A pair of coupling means 13 are provided at both the ends of the hollow cylinder 1. The coupling means 13 includes but is not limited to a flange. Alternatively, the coupling can be done through welding or other such techniques common in the art. The coupling means 13 enable coupling of the arrangement to the hot air supply duct of the fluid bed dryer. The arrangement is coupled to the hot air supply duct of fluid bed dryer just before the hot air enters the sample drying chamber of the fluid bed dryer. The arrangement eliminates static charges generated in the fluid bed dryer by neutralizing the static charges that are generated during drying of the material. The plurality of air ionizers 9 are connected to a power supply. On application of a voltage, the air ionizers emit positive ions and negative ions. These positive ions and negative ions are discharged into the hollow cylinder 1 of the arrangement. As the hot air coming from the hot air supply duct enters the hollow cylinder 1 of the arrangement, the hot air mixes with the positive ions and the negative ions; this ionized hot air then enters the sample drying chamber of the fluid bed dryer. The static charges that are generated in the fluid bed dryer during the fluidization process are neutralized by the positive ions and the negative ions that are carried by the hot air. Thus, the static charge is continuously eliminated by the continuous supply of the positive ions and the negative ions and is not allowed to build up. The arrangement as provided by the invention reduces the static charges generated in the fluid bed dryer and enables safe operation of the fluid bed dryer. The arrangement enables the fluid bed dryer to be used safely in the hazardous locations that include Class 1, Division 1, Group D classified areas. Hazardous locations consist of areas where there is the potential for a fire or explosion due to electrical equipment that is in operation in the area with a reaction to flammable or ignitable gases, liquids, vapors, combustible dusts, fibers or flying.

Example 1: In one particular example of the invention, the arrangement for reducing static charge in a fluid bed dryer include a hollow cylinder 1 having an inner surface 3 and an outer surface 7. The hollow cylinder is made of 3 mm thick SS 304 stainless steel. The diameter of the hollow cylinder is 400 mm and length of the cylinder is 800 mm. The inner surface 3 has 12 slotted projections 5 formed radially at equal intervals along the axis of the hollow cylinder 1. A bar ionizer is mounted on each of the slotted projections 5 through a U clamp 11. The arrangement is coupled to the hot air supply of the fluid bed dryer through a pair of coupling flanges. The arrangement is coupled to the hot air supply duct of fluid bed dryer just before the hot air enters the sample drying chamber of the fluid bed dryer. On application of a voltage, the bar ionizers emit positive ions and negative ions. These positive ions and negative ions are discharged into the hollow cylinder 1 of the arrangement. As the hot air coming from the hot air supply duct enters the hollow cylinder 1 of the arrangement, the hot air mixes with the positive ions and the negative ions; this ionized hot air then enters the sample drying chamber of the fluid bed dryer. The static charges that are generated in the fluid bed dryer during the fluidization process are neutralized by the positive ions and the negative ions that are carried by the hot air. Thus, the static charge is continuously eliminated by the continuous supply of the positive ions and the negative ions and is not allowed to build up. The efficiency of the arrangement in removing static charge in a fluid bed dryer is accessed and is shown in the table below.

TABLE 1
represents static charge reading recorded at four
different locations on a fluid bed dryer.

| | | Location | | Location | | Location | | Location | |
|---|---|---|---|---|---|---|---|---|---|
| S | Descrip- | 1 in FBD | | 2 in FBD | | 3 in FBD | | 4 in FBD | |
| No | tion | Peak | Avg | Peak | Avg | Peak | Avg | Peak | Avg |
| 1 | Without | 10.2 | 8.2 | 17.5 | 11.7 | 14.2 | 12.1 | 13.3 | 9.6 |
| | Ionization | | | | | | | | |
| 2 | With | 2.3 | 0.9 | 2.8 | 1.4 | 2.6 | 1.9 | 2.4 | 1.6 |
| | Ionization | | | | | | | | |

Readings are in kV

The static charges recorded at all the four locations on fluid bed dryer were significantly lower with ionization that is with the use of the arrangement as provided by the invention.

The invention thus provides an arrangement for reducing static charge in a fluid bed dryer that is cost effective, efficient, safe and even allows safe operation of fluid bed dryer in hazardous locations including Class 1, Division 1, group D classified areas.

The foregoing description of the invention has been set merely to illustrate the invention and is not intended to be limiting. Since modifications of the disclosed embodiments incorporating the spirit and substance of the invention may occur to person skilled in the art, the invention should be construed to include everything within the scope of the appended claims and equivalents thereof.

We claim:

1. An arrangement for reducing static charge in a fluid bed dryer, the arrangement comprising:
a hollow cylinder (1) having
an inner surface (3) wherein the inner surface (3) has a plurality of slotted projections (5) formed radially at equal intervals along the axis of the hollow cylinder (1); and
an outer surface (7) wherein the outer surface (7) has an ionizing apparatus (9) mounted on each of the slotted depression through a retention means (11);
wherein the arrangement allows elimination of static charges in the fluid bed dryer.

2. The arrangement as claimed in claim 1 further comprises of a pair of coupling means (13) at both ends of the hollow cylinder (1) for coupling the arrangement to the hot air supply duct of the fluid bed dryer.

3. The arrangement as claimed in claim 1, wherein the slotted depressions (5) are formed at an interval ranging from 6.5 cm to 7.5 cm.

4. The arrangement as claimed in claim 1, wherein the ionizing apparatus (9) comprises of a bar air ionizer.

5. The arrangement as claimed in claim 1, wherein the ionizing apparatus on applying a voltage, generate positive and negative ions into the hollow cylinder for neutralizing the static charge in the fluid bed dryer.

6. The arrangement as claimed in claim 1, wherein the generated positive and negative ions are carried by the hot air to the sample drying unit of the fluid bed dryer for neutralizing the static charge generated during the drying of the sample.

7. The arrangement as claimed in claim 1, wherein the retention means is a clamp, a belt or a locking flat system.

8. The arrangement as claimed in claim 1, wherein the coupling means comprises a coupling flange.
